(19) United States
(12) Patent Application Publication
(10) Pub. No.: US 2017/0227191 A1
(43) Pub. Date: Aug. 10, 2017

(54) LIGHT SHAPING DEVICE AND ARRANGEMENT

(71) Applicant: Sumolight GmbH, Berlin (DE)

(72) Inventors: DAVID YELLIN, BERLIN (DE); RALF POLACZEK, BERLIN (DE)

(21) Appl. No.: 15/302,174

(22) PCT Filed: Apr. 7, 2015
(86) PCT No.: PCT/DE2015/100145

§ 371 Date: Oct. 6, 2016

(30) Foreign Application Priority Data
Apr. 7, 2014 (DE) 10 2014 104 924.1

(51) Int. Cl. F21V 7/18; G03B 15/06; F21V 17/10; F21V 7/22; F21V 17/16

(52) U.S. Cl. CPC F21V 7/18; F21V 7/22; F21V 17/164; F21V 17/108; G03B 15/06; F21W 2131/406

(57) ABSTRACT

A self-expanding light shaping device for being separably mounted on a fastening arrangement of a lighting device is provided. The light shaping device features sidewalls of flexible material, which after the mounting on the lighting device surround a light shaping and light emitting region formed between an inlet opening and an outlet opening, tensioning elements designed for stabilizing the sidewalls and a fastening mechanism for separably mounting the light shaping device on the fastening arrangement of the lighting device, wherein the outlet opening is realized in the form of a round outlet opening, which is at least sectionally enclosed by a frontal tensioning element that expands the flexible material of the sidewalls.

### CROSS-REFERENCE TO RELATED APPLICATIONS

This application claims priority to PCT Application No. PCT/DE2015/100145, having a filing date of Apr. 7, 2015, based on DE 10 2014 104 924.1, having a filing date of Apr. 7, 2014, the entire contents of which are hereby incorporated by reference.

### FIELD OF TECHNOLOGY

The following refers to a light shaping device and arrangement.

### BACKGROUND

A light shaping device is known, for example, from document WO 2013/178222 A1.

### SUMMARY

An aspect relates to a light shaping device that has improved performance characteristics and can be used flexibly, in particular, in spotlights for photo shoots or movie shoots.

According to one aspect, a light shaping device for being separably mounted on a fastening arrangement of a lighting device is proposed. The light shaping device comprises the following components or elements: sidewalls of flexible material, which after the mounting on the lighting device surround a light shaping and light emitting region formed between an inlet opening and an outlet opening; tensioning elements designed for stabilizing the sidewalls; and a fastening mechanism for separably mounting the light shaping device on the fastening arrangement of the lighting device, wherein the outlet opening is realized in the form of a round outlet opening, which is at least sectionally enclosed by a frontal tensioning element that expands the flexible material of the sidewalls.

According to another aspect, an arrangement comprising a lighting device, particularly a spotlight, and a light shaping device, which is separably mounted on the lighting device, is proposed.

The light shaping device may be realized in the form of a self-tensioning or self-expanding light shaping device.

A reflector is formed by means of the peripheral sidewall.

The inlet opening may be realized round or polygonal, for example with four or more corners.

The frontal tensioning element may be separably arranged on the sidewalls.

The tensioning elements may feature rod elements extending from the inlet opening to the outlet opening in the longitudinal direction of the light shaping and light emitting region.

At least some of the tensioning elements may consist of or include a fiber-reinforced material, particularly of a carbon fiber-reinforced material.

The frontal tensioning element may be made of metal, for example of spring steel.

The frontal tensioning element may consist of a flat material.

A fastening arrangement for separably fastening a diffusion device (diffusor) may be arranged in the region surrounding the outlet opening and/or on an inner side of the sidewalls. The frontal tensioning element may form part of the diffusion device or be separably coupled thereto when the diffusion device is attached. The diffusion device may be designed such that it can be removed from the reflector together with the frontal tensioning element.

One or more of the tensioning elements may be arranged in assigned receptacle pockets in the sidewalls.

The light shaping device may have a collapsible design.

The fastening mechanism may feature snap fasteners and/or hook-and-loop fastener sections. One or more magnetic buttons may alternatively or additionally contribute to the fastening mechanism. The magnetic buttons may be combined with a latching means. In an embodiment, the magnetic connection can be released by laterally displacing the magnetically coupled parts relative to one another.

The fastening mechanism may feature one or more receptacle pockets, into which the ends of the tensioning elements are inserted.

At least some of the tensioning elements may be arranged in an intersecting fashion.

At least some of the tensioning elements may be arranged in a non-intersecting fashion.

The outlet opening may be at least partially covered with a light diffusion device.

The flexible material may be formed of a layered material comprising a stack of layers, wherein the following layers are provided and bonded to one another: a textile layer, a metallized polyester film layer and a white polyester film layer.

Additional aspects are described below.

Embodiments of the invention realize a light shaping device that has round emission area and can be collapsed without requiring a speed-ring (expands in itself and can be fastened directly on the spotlight without having to exert pressure upon the spotlight or a speed-ring). The light shaping device has a low weight due to the utilization of carbon fiber braces because these braces are only subjected to a very low bending force and a very small bending radius is achieved.

In practical applications, weight is an important factor because the clamp or the spherical head of a spotlight only has a certain holding power (friction). Large light shaping devices exert a significant force upon the spotlight due to the large amount of fabric used and the lever principle. Wind pressure additionally increases this force if the spotlight is used outdoors. This is the reason, for example, why light shaping devices of slightly thicker/heavier fabric can frequently not be used. Round light shaping devices are important for natural/round reflections on objects and, in particular, in the eyes. This is very important in movies.

The reflector of the light shaping device (sidewalls) may only feature straight braces, which expand the reflector in the direction between the spotlight (inlet opening) and the front of the reflector (outlet opening) at the location, at which a diffusion device (diffusor) for softening/modifying the light can be used. In this case, the reflector with the inserted braces can be collapsed to a size as small as an umbrella without having to remove any components.

The expansion of the reflector may take place in a circular direction with the aid of the diffusor, which may feature a ring of spring steel (flat steel). The diffusor may be collapsible with a twisting motion similar to a figure-eight. Expansion mechanisms of this type are known from tents and photographic reflectors. This means that the design of the diffusion device as such is known in different variations. A ring of spring steel may be located in a tube of spandex (flexible/stretchable textile). The diffusion fabric, which is typically not stretchable, may be sewn to the tube.

The diffusor needs to be connected to the reflector. Hook-and-loop fastener tape and/or snap fasteners may be used for this purpose. The hook-and-loop fastener cannot be peripherally arranged around the diffusor because hook-and-loop fastener tape is not expandable and the entire collapse and tight expansion would therefore not function. It is conceivable to merely distribute hook-end-loop fastener pieces (or pieces with snap fasteners) over the circumference. The hook-and-loop fastener tape may be interrupted in order to ensure the expandability. The reflector may feature a hook-and-loop fastener tape (optionally snap fasteners) on its inner side and the diffusor on its outer side. The diffusor is inserted into and expands the reflector.

Different (light) diffusion devices are typically used on a film set in order to achieve different effects. It is therefore required to quickly and easily exchange the diffusor. If the ring of spring steel would be removed from the reflector, the reflector would collapse and the exchange would therefore be very laborious. The diffusion material (fabric) may be easily removable from and reinsertable into the spring steel ring. One option in this respect is the utilization of a zipper. It would also be conceivable to provide more than one zipper, for example two zippers. One or more flexible zippers may also be used. Furthermore, hook-and-loop fastener tape may be alternatively or additionally used. In addition, the utilization of hook and eye fasteners would also be conceivable.

The zipper can be used for fastening the diffusion device on a spring steel ring, on which two zippers are located. The diffusion device including its steel ring can be fastened on the reflector by means of the second zipper. In an embodiment, this makes it possible to exchange the diffusion device without removing the ring. The reflector thereby remains in position. In addition, the diffusion devices can be manufactured more cost-efficiently and are also smaller and therefore easier to transport.

A white or diffuse reflector material (for example with textile) may be used because silvery (mirror-like) material can lead to an uneven illumination of the diffusor (diffusion device).

Conventional white, textile-based reflector material is typically not very reflective. This means that much light is lost because the light is reflected back and forth several times in the interior between the diffusion device and the reflector. This can lead to the uneven illumination, i.e. an undesirable hotspot in the center. Until now, it was frequently attempted to prevent a hotspot in the center of the diffusion material by providing a second inner diffusor, which may have a smaller diameter than the reflector at the corresponding location and/or features several textile layers in the center. However, it is disadvantageous that this second diffusor absorbs much light. This is especially problematic when using LEDs and, in particular, battery-operated spotlights because these light sources only provide a limited number of lumens.

The higher the reflectance of the reflector material, the more evenly the illumination of the diffusion device and the higher the luminous efficiency or illuminance because the light is reflected back and forth several times between the diffusion material and the reflector. The second inner diffusor can be eliminated if a highly reflective (diffuse) reflector is used. A high efficiency can thereby be achieved (50-100% higher illuminance with the same number of lumens of the light source).

An efficient and lightweight reflector or reflection material can be realized by coating a textile with a metallized foil that is highly light-reflective, particularly a silver foil. This highly reflective layer may be coated with a matte material, for example a white material that is highly reflective (white PE or polyester). In this case, it is advantageous that the white material can be realized very thin and that the textile has a low weight, but nevertheless prevents light from being emitted on the rear side.

The reflector material may be structured as follows: a textile (polyester), preferably 150-210 denier nylon (very durable), then a metallized (aluminum) polyester film layer (selectively metallized on both sides), and ultimately a white polyester film layer, wherein all layers are bonded together with clear adhesive. In order to increase the strength, an intermediate layer of intersecting thick threads, which are spaced apart by a large distance (about 20 mm) and form a rhomboidal pattern, may be inserted between the textile and the metallized polyester film. This only leads to a slight weight increase of the reflector material, but its strength is increased significantly. This structure results in a very efficient, lightweight, diffuse and also cost-effective reflector material.

The material for the reflector can not only be used in the light shaping device, but also in other light reflector or light reflection devices such as, for example, in a flat or curved planar reflector, particularly in light reflector or light reflection devices for photo shoots or movie shoots.

According to an independent and alternative aspect, a layered material comprising stacked layers forms a reflector material, i.e. a light-reflecting, textile-based material, wherein the following layers are provided and bonded to one another: a textile layer, a metallized polyester film layer, which is arranged on the textile layer and may be metallized on one or both sides; and a white polyester film layer arranged on the metallized polyester film layer. An intermediate layer of intersecting threads may be arranged between the textile layer and the metallized polyester film layer.

The reflector material may alternatively feature the following: a black textile fabric, particularly a black nylon fabric such as, for example, ripstop nylon (70D); a black adhesive; a reflective film double-coated with silver; a transparent adhesive and a white textile fabric, particularly a white nylon fabric such as, for example, ripstop nylon (70D). In this way, a high reflectance and a matte, omnidirectional reflection can be achieved. The material is furthermore robust and tear-resistant. A second textile layer is also provided. The reflector material may have a layered structure of this type.

In an alternative embodiment, the reflector material may feature the following: a black textile fabric, particularly a black nylon fabric such as, for example, ripstop nylon (70D); a black adhesive; a white film; a transparent adhesive, a reflective film double-coated with silver; a transparent adhesive and a white textile fabric, particularly a white nylon fabric such as, for example, ripstop nylon (70D). The reflector material may also have a layered structure of this type.

### BRIEF DESCRIPTION

Some of the embodiments will be described in detail, with reference to the following figures, wherein like designations denote like members, wherein:

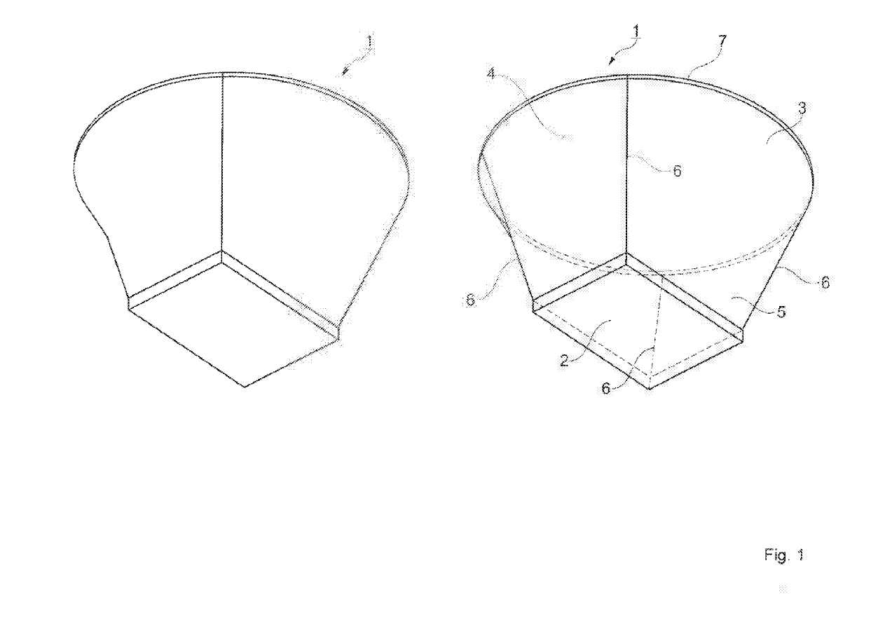

FIG. 1 shows a schematic representation of a light shaping device with an inlet opening and an outlet opening;

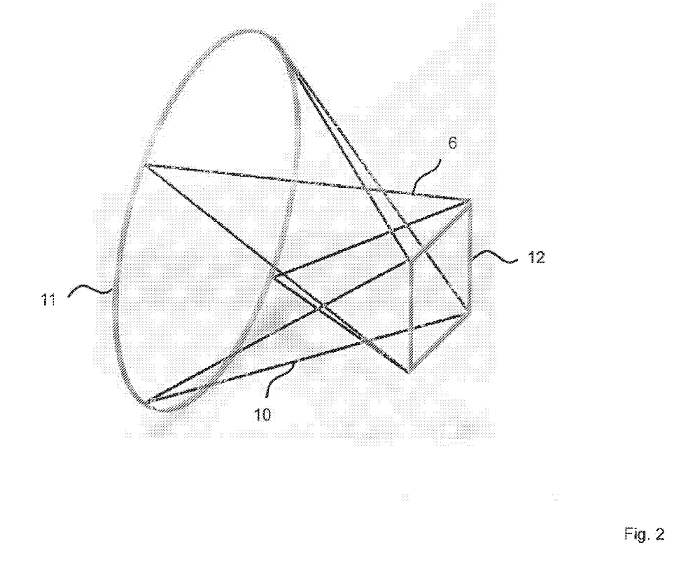

FIG. 2 shows a schematic perspective representation of a tensioning device (basic construction) for another light shaping device;

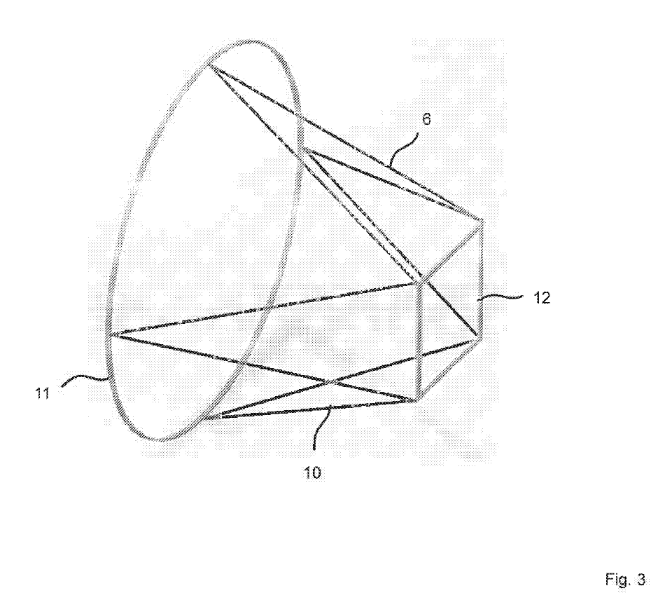

FIG. 3 shows a schematic representation of a tensioning device for an additional light shaping device;

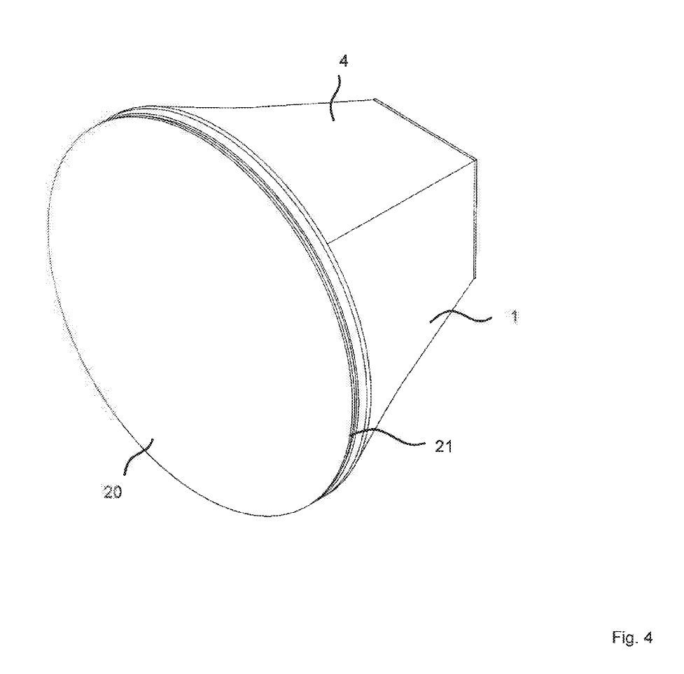

FIG. 4 shows a perspective representation of a light shaping device, on which a diffusion device is arranged in the region of an outlet opening;

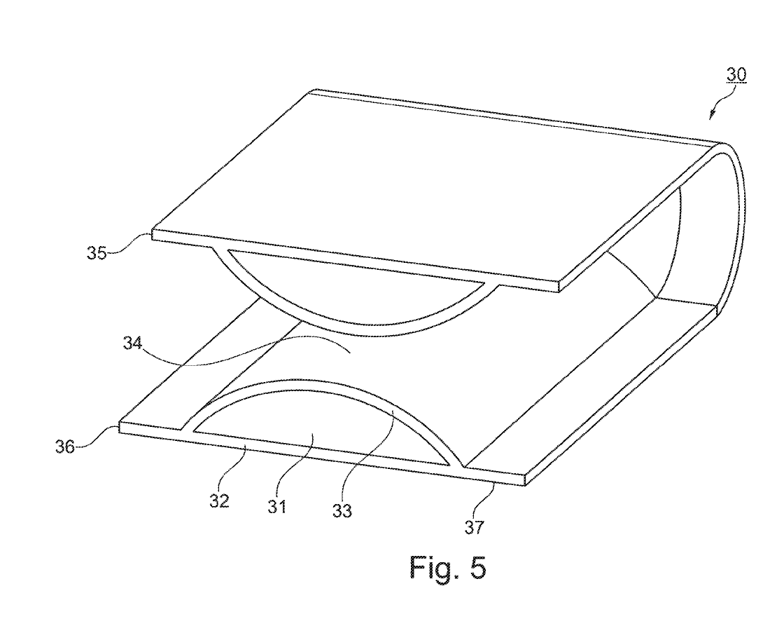

FIG. 5 shows a perspective representation of a receptacle pocket;

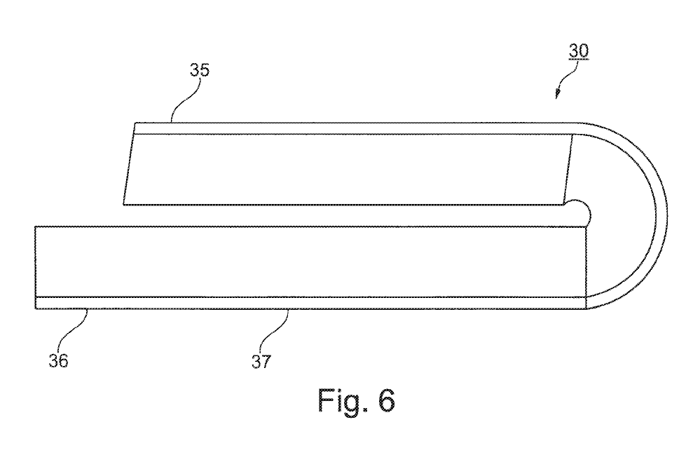

FIG. 6 shows a side view of the receptacle pocket; and

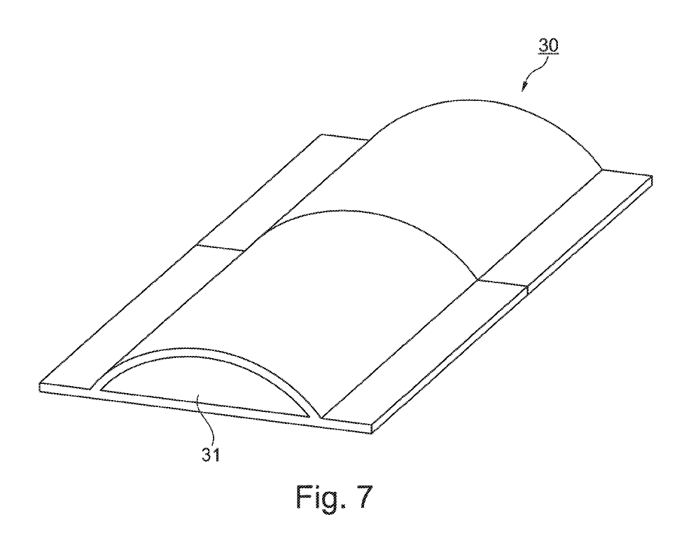

FIG. 7 shows a perspective representation of the receptacle pocket according to FIG. 5 in an expanded state.

### DETAILED DESCRIPTION

FIG. 1 shows an exemplary light shaping device 1 with an inlet opening 2 and an outlet opening 3. A light shaping and light emitting region 4, the peripheral sidewall 5 of which consists of a flexible material, for example of a textile material, extends between the inlet opening 2 and the outlet opening 3. This material can also be referred to as reflector material. Tensioning elements 6 are provided in order to stabilize the sidewall. The tensioning elements 6 extend in the longitudinal direction of the light shaping and light emitting region 4 and are angled relative to the center axis of the light shaping and light emitting region 4.

The tensioning elements 6 originate from corner regions of the rectangular inlet opening 2.

The outlet opening 3 is realized in the form of a round outlet opening, which is at least sectionally enclosed by a frontal or outlet side tensioning element 7 that expands the flexible material of the sidewall 5. The frontal tensioning element 7 is made of a flat material, for example of spring steel.

The thusly created light shaping device has a round emission area, is very efficient, provides uniform illumination, has a very low weight and therefore can also be realized very large (with a diameter of 135 cm or more) and used for smaller spotlights, particularly LED spotlights, the clamping system of which typically is only designed with a low holding power. It furthermore has a small packing size and can be cost-effectively manufactured.

FIG. 2 shows a perspective representation of a basic construction 10 for a light shaping device in the form of a frame, in which the tensioning elements 6 extending between the inlet opening 2 and the outlet opening 3 intersect one another in pairs. The tensioning elements 6 extend between an outlet side tensioning element 11 and an inlet side tensioning element 12, wherein the outlet side tensioning element 11 is realized in the form of a ring in the embodiment shown. The inlet side tensioning element 12 has a rectangular shape.

FIG. 2 shows the basic construction 10 in the erected or expanded state. In order to form the light shaping device, the outer side of the basic construction is covered with reflector material in the region between the outlet side tensioning element 11 and the inlet side tensioning element 12. In this case, the reflector material is separably or inseparably fastened on the outlet side tensioning element 11 and the inlet side tensioning element 12, for example sewn around said tensioning elements. The ends of the tensioning elements can be separably inserted into (not-shown) assigned pockets on the inner side of the reflector material. The pockets may be realized in the form of receptacle pockets, for example as described below with reference to FIG. 5-7.

The outlet side tensioning element 11 and the inlet side tensioning element 12 of the additional light shaping device according to FIG. 3 are realized similar to the embodiment illustrated in FIG. 2. However, the tensioning elements 6 are arranged in a non-intersecting fashion in the embodiment according to FIG. 3.

FIG. 4 shows a perspective representation of the light shaping device 1. A light diffusion device 20 is arranged in the region of the outlet opening 3 and separably attached thereto by means of a schematically illustrated zipper 21. The zipper may be sewn to the reflector material.

FIG. 5-7 show representations of a receptacle pocket 30, which is arranged on the inner side of the light shaping devices in the light shaping region 4 in order to receive end sections of the tensioning elements 6, particularly end sections arranged proximal to the frontal or inlet side tensioning element 7, 12. The receptacle pocket 30 has a receptacle space 31, which is formed between an upper and a lower section 32, 33 of the receptacle pocket 30.

FIG. 5 shows the receptacle pocket 30 in a folded state, wherein a hook-and-loop connection may be produced in an intermediate region 34 between the sections 35, 36 of the receptacle pocket 30. In order to attach the receptacle pocket to the inner side of the light shaping device, its rear side 37 may be connected to the reflector material, for example, sewn or fastened thereon by means of hook-and-loop fastener tape. The receptacle pocket 30 may be sewn to the inner side of the peripheral sidewall 5 of the light shaping device 1.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A light shaping device for being separably mounted on a fastening arrangement of a lighting device, comprising:
sidewalls of flexible material, which after the mounting on the lighting device surround a light shaping and light emitting region formed between an inlet opening and an outlet opening,
tensioning elements designed for stabilizing the sidewalls, and
a fastening mechanism for separably mounting the light shaping device on the fastening arrangement of the lighting device,
wherein the outlet opening is provided in the form of a round outlet opening, which is at least sectionally enclosed by a frontal tensioning element that expands the flexible material of the sidewalls.

2. The light shaping device according to claim 1, wherein the tensioning elements feature rod elements extending from the inlet opening to the outlet opening in the longitudinal direction of the light shaping and light emitting region.

3. The light shaping device according to claim 1, wherein at least some of the tensioning elements consist of a fiber-reinforced material, having a carbon fiber-reinforced material.

4. The light shaping device according to claim 1, wherein the frontal tensioning element is made of metal.

5. The light shaping device according to claim 1, wherein the frontal tensioning element is made of a flat material.

6. The light shaping device according to claim 1, wherein a fastening arrangement for separably fastening a diffusion device is arranged in the region surrounding the outlet opening and/or on an inner side of the sidewalls.

7. The light shaping device according to claim 1, wherein one or more of the tensioning elements are arranged in assigned receptacle pockets in the sidewalls.

8. The light shaping device according to claim 1, comprising a collapsible design.

9. The light shaping device according to claim 1, wherein the fastening mechanism features a snap fasteners and/or hook-and-loop fastener sections.

10. The light shaping device according to claim 1, wherein the fastening mechanism features one or more receptacle pockets, into which the ends of the tensioning elements are inserted.

11. The light shaping device according to claim 1, wherein at least some of the tensioning elements are arranged in an intersecting fashion.

12. The light shaping device according to claim 1, wherein at least some of the tensioning elements are arranged in a non-intersecting fashion.

13. The light shaping device according to claim 1, wherein the outlet opening is at least partially covered with a light diffusion device.

14. The light shaping device according to claim 1, wherein the flexible material is formed by a layered material with a stack of layers, wherein the following layers are provided and bonded to one another: a textile layer, a metallized polyester film layer and a white polyester film layer.

15. An arrangement comprising a lighting device, particularly a spotlight, and a light shaping device according to claim 1, which is separably mounted on the lighting device.
